(19) United States
(12) Patent Application Publication
(10) Pub. No.: US 2010/0070290 A1
(43) Pub. Date: Mar. 18, 2010

(54) Get home smart card

(76) Inventors: Rosette Marturana, Mt. Prospect, IL (US); Geralyn Jackman, Palatine, IL (US)

Correspondence Address: Rosette Marturana, 1401 N. Sauk Lane, Mt. Prospect, IL, 60056, US

(21) Appl. No.: 12/283,632

(22) Filed: Sep. 15, 2008

(51) Int. Cl. G06Q 10/00

(52) U.S. Cl. 705/1

(57) ABSTRACT

A gift card and toll free number for the sole purpose of a Taxi ride to a residence or motel/hotel. Gift card will be sold at retail establishments in specific monetary increments. Gift card is a four part card assembly that has a magnetic stripe, barcode, individually numbered, keytag, aperture and portion for monetary increments. There is a toll free number which will be used to contact a Taxi member by entering zip code for dispatch. There will be a website. A specific amount of gratuity will be automatically paid to destination balance.

1. This service is to be used for the Sole purpose of transportation by a Taxi Service to transport a customer to a Smart destination of a residence, hotel/motel and such.
2. The Get Home Smart Card will Not be used to go from one drinking establishment to another.
3. The Get Home Smart Card Campaign is to provide a Smart and safe way home.
4. One less impaired driver can make a World of Difference.
5. There will be a designated Toll Free Number/Text for the consumer to call for the Get Home Smart Card Services.
6. Get Home Smart Card is sold only in specified increments.
7. Get Home Smart Card is activated for the specified amount at place of purchase at time of purchase.
8. Get Home Smart Card is Not redeemable for cash.
9. Get Home Smart Card retailer establishment may charge consumer an agreed upon fee for activating/selling the Get Home Smart Card.
10. The retail establishment that sells the Get Home Smart Card gift card will have an option to be a part of the Get Home Smart Card campaign and sell the Get Home Smart Card for no added fee.
11. Get Home Smart Card may charge a to be determined fee at time of purchase. There will be a Magnetic Data Stripe on the back side of the Get Home Smart Card gift card along with disclaimer information. A recording data on the magnetic strip includes recording unique customer data on the magnetic stripe, with the amount of currency which is directly connected to that individual gift card.
12. Each Get Home Smart Card gift card will be assigned it's own individual number, providing information for that gift card only. For identifying purposes, such as keeping track of card activation, for customer registration, for a lost or stolen card, and to keep records of card use, not to be limited to only these uses.
13. The gift card will have a Smart keytag that will have the Get Home Smart Card.com logo on the front side and the back side will have a toll free number and text “phrase” or may have a “alphanumeric” text along with sponsors information.
14. The Smart keytag's can be given away to promote the Get Home Smart Card gift card and toll free services.
15. Get Home Smart Card will hold it's Balance in full with no expiration date. Consumer can check balance of Get Home Smart Card gift card on website.
16. Get Home Smart Card can be replenished on line only at Get Home Smart Card.com for a re-use/recycle feature.
17. There may be a replenish fee when consumer adds money to their account on the Get Home Smart Card.com website.
18. The Get Home Smart Card with the re-use/recycle feature will be a part of the Green program
19. Consumer will have the option to register the Get Home Smart Card gift card on the website to insure if the Get
20. Home Smart Card gift card is lost, stolen or damaged. The Get Home Smart Card gift card will be replaced at the value registered on their account on the date of request, by consumer going to the Get Home Smart Card.com website and reporting the problem.
21. The previous Get Home Smart Card gift card will automatically be terminated. The new Get Home Smart Card gift card will be mailed to registered consumer only, there may be a small mailing fee.
22. Any lost, stolen or damaged Get Home Smart Card gift card that are not registered on the website will not be refindable or replaced.
23. With a credit card/debit card option, on Get Home Smart Card.com website, consumer can choose to keep a desired balance at all times or add desired amount in specific increments by using their credit/debit card.
24. There will be a designated toll free number for consumer to call that will be on the front of the Get Home Smart Card gift card and on the key tag. When calling the toll free service customer is to following the prompts by first entering the zip code of the location they are calling from, using their cell or land line keypad. This will then automatically call the next taxi in the rotation and the consumer will tell dispatcher location they are at and the location of their Smart destination such as resident or motel/hotel. The taxi company will then dispatch a car for this customer.
25. There will be an option for consumer to text to a certain “phrase” or may have a “alphanumeric” text which will automatically connect them to the toll free number. The customer is to follow prompts on the toll free number to enter the zip code they are calling from on the phone keypad. This will then automatically call the next taxi in the rotation and the consumer will tell dispatcher location they are at and the location of their Smart destination such as resident or motel/hotel. The taxi company will then dispatch a car for this customer.
26. The Taxi companies will get business from a consumer using the Get Home Smart Card or just by dialing the Get Home Smart Card toll free number.
27. No membership fee for Taxi companies.
28. Taxi companies that want to be a member with the Get Home Smart Card service can go to website and for Free by entering the zip codes that they service and all their vital information as will be stated on the website. This will be a binding contract between the Taxi company and Get Home Smart Card service.
29. Taxi services will be self programming the website with their information.
30. Website will automatically store all this information. All information is private.
31. The taxi services that are members in exchange will advertise for Get Home Smart Card by putting stickers, magnetic decals advertisement on their vehicles to show they are a member of this service and to promote safety.
32. Taxi services can ONLY bring consumer to a smart destination such as a residence or hotel/motel of choice, per agreement with the Get Home Smart Card.
33. Get Home Smart Card will have a set agreed amount of Gratuity automatically added to destination balance of Taxi services for customer to pay at the time of service. The taxi service may have to add this at time of service.
34. Get Home Smart Card is Valid for participating United States Taxi services only.
35. Every time a consumer calls the toll free number and the call gets dispatched to a Taxi service, that Taxi service will pay Get Home Smart Card Company an agreed fee per dispatch.
36. Taxi services that are members of the Get Home Smart Card will receive a monthly statement of transactions of dispatches that they serviced through the Get Home Smart Card toll free number, per the contract agreement. The Taxi service will pay this monthly total of transactions by auto debit per contract agreement.
37. Every time the toll free number service is used, for a certain zip code area, the system will dispatch a Taxi service that is a member. For the next call a different Taxi service will get the business. This will be on a constant rotation giving all different Taxi members an even share of the dispatches as they are received.
38. The continuous rotation will fairly go through all the members of the zip coded areas being requested by the customer. The programs system will keep track of which company is next in the rotation for the next customer pick up.
39. Get Home Smart Card is not responsible for any liability of any Taxi Service and/or Taxi Employee, per contract agreement.
40. Get Home Smart Card.com Company is not responsible for any liability, action or conduct of any customer using the Get Home Smart Card or the Get Home Smart Card toll free number.
41. The Taxi Driver can swipe the magnetic stripe in the credit card processor to obtain card holders balance.
41. All Fees are to be determined.
41. All Fees are to be determined.

### SUMMARY OF INVENTION AND SELL

### The Get Home Smart Card Purpose is:

1. For the sole purpose of transportation to consumer residence of choice including Hotels/Motels.
2. This service Can Not to be used to go from one drinking establishment to another.
3. “One less impaired driver can make a world of difference.”
4. Campaign to eliminate drunk driving by awareness of the Get Home Smart Card Services.
5. For the safety of the public.
6. This is a Smart positive alternative to driving impaired.
7. Unfortunately Consumption has no age limit.
8. A Smart gift for loved one's of all ages.
9. Not only for impaired drivers, also for Emergency purpose.
10. Perfect for Teenagers to keep in their wallet, purse, backpack, etc.—in case of an emergency—to be able to get home and not have to worry about having enough money for a Smart ride home.
11. Perfect for College Students for emergency purposes, this will give them a great option for safety.
12. Perfect for Young Adults of legal drinking age to have a positive choice by using the Get Home Smart Card instead of getting in a vehicle of any impaired driver—themselves or a friend.
13. Perfect for Senior Citizens that no longer drive.
14. The Smart keytag reminder to place on your key chain.
15. This Gift Card will hold Balance with no expiration date.
16. The Get Home Smart Card with the re-use/recycle feature will be a part of the Green program.
17. Keep Neighborhoods street and highways safe.
18. Added safety for pedestrians and pets.
19. To reduce fatalities and injuries from drivers under the influence of drugs and/or alcohol.
20. This unique service will lower the expense's from injuries, car insurance, hospitalization and DUI's.
21. This service will alleviate pain and suffering that is caused by impaired drivers that cause victim's and their families anguish and heartache.
22. This easy service can be used with or without a Smart card by dialing the toll free number/text.
23. After calling the toll free number consumer is to follow the prompts to enter the zip code of their location for Taxi Service.
24. A text messaging option for this service may also be available by the customer to text a certain “phrase” or may have an “alphanumeric” text that will connect them to the toll free number where they are to follow the prompt to enter the zip code of their location for Taxi Service.
25. To Promote this campaign Get Home Smart Card will give stickers, magnetic decals and keytags to alcohol serving or selling establishments.
26. Our goal is to get this project sponsored by reputable organization(s) that promote safety.
27. The retail establishment that sells Get Home Smart Card gift card's will have an option to be a part of this campaign and sell the Get Home Smart Card gift card for no added fee.
28. No membership fee for Taxi Companies to join.
29. Free sign up for Taxi Services.
30. To be a member of the Get Home Smart Card services Taxi Companies are to go to website and enter the zip codes that they service and all their vital information as will be stated on the website. This will be a binding contract between the Taxi company and Get Home Smart Card service.
31. The Taxi Services that are members in exchange will advertise for Get Home Smart Card by putting stickers, magnetic decals advertisement on their vehicles to show they are a member of this service and to promote safety.
32. The Taxi Companies will get business by a consumer using a Get Home Smart Card and by dialing the toll free number and by giving keytag to customers.
33. A specific agreed amount of Gratuity, with the Taxi
34. Company, will automatically be added to the destination balance for the customer to pay at the time of service.

### BRIEF DESCRIPTION OF DRAWINGS

### Located on Front of Card

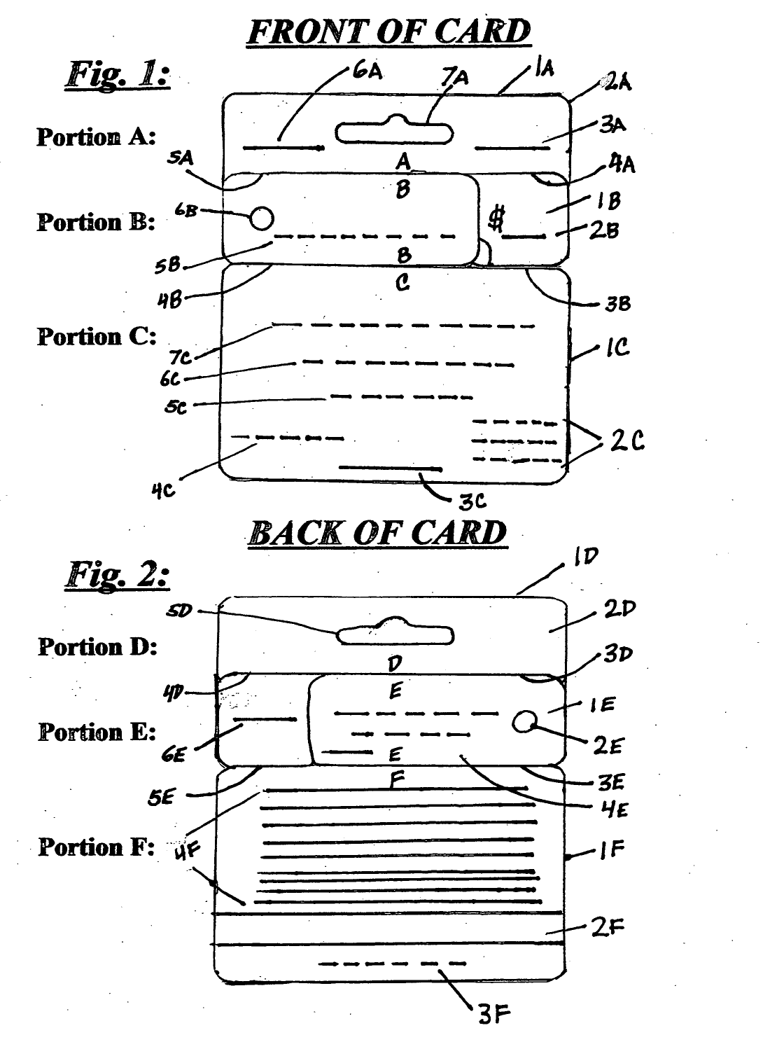

FIG. 1:

### Portion A:

1A: Card packaging assembly, made from a single plastic sheet.

### Dimensions: L-3¼×W-30 mil.×H-3¾

Include perforated lines with a weakened scored portion

2A: Top portion of assembly, that includes the aperture include perforated lines with a weakened scored portion. Separating from Portion A from Portion B.

Dimensions: L-3¼×W-30 mil.×H ¾

3A: Barcode for Sale Purposes at Retail Establishments.

4A: Display portion with Perforated lines with a weakened scored portion for customer removal separating Portion A from Portion

5A: Display portion with Perforated lines with a weakened scored portion for customer removal separating Portion A from Portion B.

6A: Logo/Trademark/Campaign/Slogan space. To be determined.

7A: Geometric Aperture for card display from a peg, etc. All though the aperture is shown in the invention one way it is not so limited.

### Portion B:

1B: Middle Portion of assembly, that include perforated lines with a weakened scored

Portion. Separating from portions A and B. Also separating key tag and monetary money Portion.

### Dimension: L-3¼×W-30 mil.×H-⅞

2B: Specific Monetary Value of Gift Card such as $25.00, $35.00, but not so limited. This Portion is to be Removed and Recycled.

### Dimension: L-⅞×W-30 mil.×H-⅞

3B: Display portion with Perforated lines with a weakened scored portion for customer removal from portion B from Portion C.

4B: Display portion with Perforated lines with a weakened scored portion for customer removal from Portion B from Portion C.

5B: Keytag apparatus with the Get Home Smart Card.com Logo/website address.

Dimension: L-⅞×W-30 mil×H-2⅜

6B: Keytag hole for customer to attachment to keychain.

Portion C:

1C: Front side of Get Home Smart Card Gift Card.

### Dimension: L-3¼×W-30 mil.×H-2⅛

2C: Information on how to use our automated service after calling toll free number or texting by entering Zip Code of pick up location.

3C: Environmentally friendly re-usable statement.

4C: Location designated to Sponsors.

5C: Text “Phrase” or can be an “alphanumeric” text which will automatically connect to our toll free number.

6C: Get Home Smart Card Toll Free Telephone Number.

7C: Logo/Web address: Get Home Smart Card.com.

### Located on the Back of Card:

FIG. 2:

### Portion D:

1D: Card packaging assembly, made from a single plastic sheet.

### Dimensions: L-3¼×W-30 mil.×H-3¾

Include perforated lines with a weakened scored portion

2D: Top portion of assembly, that includes the aperture that for displaying Gift Card from a hook or such. Include perforated lines with a weakened scored portion.

Dimensions: L-3¼×W-30 mil.×H ¾

3D: Perforated line with a weakened scored portion Separating from Portion D from Portion E.

4D: Perforated line with a weakened scored portion Separating from Portion D from Portion E.

5D: Geometric Aperture for card display from a peg, etc. All though the aperture is shown in the invention one way it is not so limited.

### Portion E:

1E: Middle portion of assembly, that include perforated lines with a weakened scored portion. Separating from Portions E and F. Also separating keytag and monetary money portion.

### Dimension: L-3¼×W-30 mil.×H-⅞

2E: Keytag hole for customer to attach to keychain.

3E: Perforated line with a weakened scored portion Separating from Portion E from Portion F.

4E: Keytag apparatus with Get Home Smart Card Toll Free Telephone Number, text phrase or alphanumeric and sponsors.

Dimension: L-⅞×W-30 mil×H-2⅜

5E: Perforated line with a weakened scored portion Separating from Portion E from Portion F.

6E: This portion is to be removed and recycled.

### Dimension: L-⅞×W-30 mil.×H-⅞

### Portion F:

1F: Back side of the Get Home Smart Card Gift Card.

### Dimension: L-3¼×W-30 mil.×H-2⅛

2F: A recording data on the magnetic stripe includes unique customer data that holds the monetary information for each individual card.

3F: Each gift card will be assigned it's own individual number, providing information for that gift card only. For identifying purposes, such as keeping track of gift card activation, for customer registration, for a lost or stolen gift card, and to keep records of gift card use, not to be limited to only these uses.

4F: Disclaimer and description of uses and terms and conditions of Gift Card.

Although this invention is shown one way it is not so limited.

4F:

Disclaimer and description of uses and terms and conditions of Gift Card.

Located on the back of the gift card:

Visit www.GetHomeSmartCard.com to register gift card to insure Lost, Stolen or damaged gift cards to be replaced at value at time of request.

Non-registered Gift Card will not be refunded or replaced.

Card is to be used only for the Sole purpose of transportation to a Smart destination including customers residence of choice or motel/hotel.

Get Home Smart Card Company is not responsible for any liability, action or conduct of any Taxi Service and/or Taxi employee.

Get Home Smart Card Company is not responsible for any liability, action or conduct of any Customer.

Gift Card is not redeemable for cash or other services besides what is stated.

A specific agreed amount of Gratuity will automatically be added to destination balance of Taxi Service for customer to pay at the time of service.

Gift Card will hold Balance with no expiration date.

Re-use/Recycle by Replenishing card at www.GetHomeSmartCard.com to add money to account. Although this invention is shown one way it is not so limited.

Card display system and method:

A system and method for displaying a presentation instrument such as a gift card, and for establishing and maintaining an account associated with the gift card. The gift card is packaged with a card carrier for display at a retail establishment, with the gift card having an identifying element, such as a magnetic stripe and bar code. The identifying element on the gift card may be electronically read in order to conduct transactions against the account. The printed card assembly, wherein the gift card and the card carrier are formed from a single plastic sheet. To save on manufacturing costs and an eco friendly card that is recyclable by replenishing the funds to re-use. The present invention relates to card, packaging assemblies that have removable portions: a card portion, a carrier portion and a keytag portion. Machine readable indicia for activating the card at the point of sale can be located on the back side of the gift card and such indicia is adapted to be easily readable by such point of sale device. Each of the gift card and carrier portions can be made selectively removable from one another. Include perforated lines with a weakened portion that includes a scored portion. Other embodiments of weakened portions include perforated lines, etc. In one embodiment, such as a gift card embodiment, an aperture is included for card display from a peg, etc. Although a particular geometry of aperture is shown in the invention it is not so limited. Other shapes of holes, slots, etc. are also within the scope of the invention. There will be a Barcode for Sale Purposes at Retail Establishments located on this portion. This is for consumer to remove this portion from the card for use. In the Middle Portion of assembly, that include perforated lines with a weakened removable scored Portions, this is the Keytag apparatus with the Get Home Smart Card.com Logo/Website address on front side and toll free number/text phrase on the back side, also may include sponsor. On the other portion of this key tag there will be a removal piece that will have the Specific Monetary Value of the Gift Card such as $25.00, $35.00 but not so limited. This piece is removable with break away portion that is to be removed and recycled. The bottom portion is the gift card. The identifying element such as a magnetic stripe on the back of the gift card can be electronically read in order to conduct transactions against the account. The system uses a communications network for issuance, activation, and accounting, and such. Each gift card will be assigned it's own individual number, providing information for that gift card only. For identifying purposes, such as keeping track of gift card activation, for customer registration, for a lost or stolen gift card, and to keep records of gift card use, not to be limited to only these uses. A consumer purchases the gift card for a particular amount of money. The cash value of the card is typically stored in either of two ways. The value can be indicated by data stored in the memory of the card. Alternatively, in a card having a magnetic stripe or in some cards having an integrated circuit (“IC”) on them, value is indicated by data stored in a central host, which can be accessed using information stored on a magnetic stripe on the back of the card. Verification of the identity of the purchaser of the card is typically not required. With either an IC-type card or a magnetic stripe-type card. When a consumer uses a gift card to make a purchase of a Taxi ride, the data indicating the value currently associated with the gift card is decreased by the amount of the purchase and any fees, if applicable. A system and method for displaying a presentation purchase of a gift card, through an agent such as a retail establishment via an electronic card swipe terminal. Have the gift card activated at the point of purchase, use the card to purchase services of the Get Home Smart Card and re-use/recycle the card for future use at Get Home Smart Card.com. The system uses a communications network for issuance, activation, and accounting, and activation is accomplished on a real-time basis, one account at a time. The gift card can be used to purchase a service performed by a participating Taxi Company only.

1. A method for using a gift card for the sole purpose of transportation to a residence or hotel/motel. By either using the gift card or the toll free number, payment to be issued only to Taxi company for service rendered, gratuity included.
